(19) United States
(12) Patent Application Publication
(10) Pub. No.: US 2011/0076373 A1
(43) Pub. Date: Mar. 31, 2011

(54) POPCORN MACHINES AND OTHER MACHINES HAVING REVERSIBLE FOOD MOVING DEVICES FOR POPPING POPCORN AND PRODUCING OTHER TYPES OF EXPANDED FOODS

(75) Inventors: Charles D. Cretors, Lake Forest, IL (US); Frank Strawn, Deer Creek, IL (US)

(73) Assignee: C. Cretors & Company, Chicago, IL (US)

(21) Appl. No.: 12/891,722

(22) Filed: Sep. 27, 2010

Related U.S. Application Data
(60) Provisional application No. 61/247,394, filed on Sep. 30, 2009.

(51) Int. Cl. A47J 27/00; A23L 1/18; A23P 1/14

(52) U.S. Cl. 426/450; 99/323.9; 426/445

(57) ABSTRACT

Machines having reversible food moving devices for making popcorn and other types of expanded food products are described herein. In one embodiment, a popcorn machine includes an auger that moves a mixture of raw corn kernels and cooking oil along a trough-shaped cooking surface. In this embodiment, the auger can cyclically reverse direction for a predetermined period of time before resuming rotation in the forward direction to facilitate favorable popping of the popcorn. In one aspect of this embodiment, the auger can rotate through a greater angle of rotation in the forward direction than in the reverse direction in each cycle, so that the auger progressively moves the unpopped corn kernels along the entire cooking surface until they ultimately pop and/or are dispensed into a suitable receptacle. In one embodiment, the popcorn machine can also include two or more heating zones to provide favorable popping characteristics.

### CROSS-REFERENCE TO RELATED APPLICATION(S) INCORPORATED BY REFERENCE

The present application claims priority to and the benefit of U.S. Provisional Application No. 61/247,394, filed Sep. 30, 2009, and entitled “POPCORN MACHINES AND OTHER MACHINES HAVING REVERSIBLE FOOD MOVING DEVICES FOR POPPING POPCORN AND PRODUCING OTHER TYPES OF EXPENDED FOOD,” which is incorporated herein by reference in its entirety.

### TECHNICAL FIELD

The following disclosure relates generally to systems and methods for popping corn and producing other types of expanded foods.

### BACKGROUND

Popcorn machines for use in theaters, concession stands, and homes are well known. Industrial machines for making large quantities of popcorn, puffed rice, and other expanded food products for wholesale to retailers are also known. Conventional popcorn machines typically include a popping kettle positioned inside a cabinet. To make popcorn, unpopped corn kernels are placed in the kettle with cooking oil and heated with a gas burner or electric heating element. The cooking oil coats the kernels and ensures a relatively even distribution of heat throughout the kernel.

Agitating the kernels can prevent them from burning on the bottom of the kettle where the heat is most intense. For this reason, many popcorn machines include some type of agitator that mixes the corn kernels with the cooking oil and ensures even popping. Some machines, for example, include stirring blades that are mounted to a rotating shaft driven by an electric motor. In operation, the stirring blades sweep around the inside of the popping kettle, mixing the kernels with the cooking oil and ensuring the kernels are evenly heated.

In conventional popcorn machines, the temperature of the popping surface is thermostatically controlled to a uniform temperature of about 480° F. When the corn kernels and oil are poured onto the hot surface, the temperature of the surface initially drops to about 380° F. Over the next three to four minutes, the temperature rises back to approximately 480° F. and the kernels begins to pop. Most conventional kettles have a lid that allows the popped corn to spill out of the kettle as the volume of popped corn increases. When the popping operation is complete, the kettle can be tilted to dump any remaining popcorn onto the floor of the cabinet, and the cycle can be repeated. After popping, butter, oil, caramel, and/or other flavorings can be added to the popcorn if desired.

Corn kernels are pressure vessels that consist of about 14% moisture. When heated, the starch in the kernel becomes gelatinized (i.e., a thick liquid) and the moisture turns to steam which raises the internal pressure. When the internal pressure reaches about 135 pounds per square inch (PSI), the kernel explodes. As the kernel explodes, the steam expands and stretches the starch cells as the pressure drops to atmospheric. The temperature drops with the dropping pressure, and the starch freezes into a foam structure having a volume that is about 50 times greater than the original kernel.

Although heat is applied to the outside of the kernel during the popping process, the kernel is preferably cooked to the core for satisfactory popping. If the kernel is heated too rapidly, the kernel will pop before it is cooked to the core and the center will be hard and less satisfactory for eating. Conversely, if the kernel is heated too slowly, all the moisture may leak out before it reaches popping pressure.

### BRIEF DESCRIPTION OF THE DRAWINGS

FIG. 1 is a partially schematic isometric view of a popcorn machine having a reversible food moving device configured in accordance with an embodiment of the disclosure.

FIG. 2 is an enlarged end view of a cooking assembly from the popcorn machine of FIG. 1.

FIGS. 3A and 3B are side cross-sectional views of the popcorn machine of FIG. 1.

FIG. 4 is a schematic diagram of a flow routine illustrating a method for operating a food moving device in a popcorn machine in accordance with an embodiment of the disclosure.

FIG. 5 is a schematic diagram of a flow routine illustrating a method for operating a food moving device in a popcorn machine in accordance with another embodiment of the disclosure.

FIG. 6 is a partially schematic isometric view of a popcorn machine having a reversible food moving device configured in accordance with another embodiment of the disclosure.

### DETAILED DESCRIPTION

The following disclosure describes various embodiments of popcorn machines and other machines for producing expanded food that have reversible drive systems (e.g., an auger) that can move food in two directions (e.g., forward and back) on a cooking surface. In one embodiment, for example, a popcorn machine has a reversible auger with a spiral blade that moves raw popcorn kernels (or other food product) along a heated, trough-shaped cooking surface by repeatedly moving the corn forward a first amount and then back a second, lesser amount. More specifically, in this embodiment the auger rotates in a first direction to move the corn kernels forward a first distance, and then in the reverse direction to move the corn kernels back a second distance that is less than the first distance. These phases of auger rotation continue in a repeating cycle; and because the auger rotates further in the first direction in each cycle than in the second direction, the net result is that the auger ultimately moves the corn over the entire length of the cooking surface. The back and forth movement of the popcorn kernels provides good agitation of the corn and keeps it immersed in the cooking oil for even heating. In contrast, rotation of the auger in a single direction tends to push the corn up the sidewall of the trough-shaped cooking surface and away from the oil.

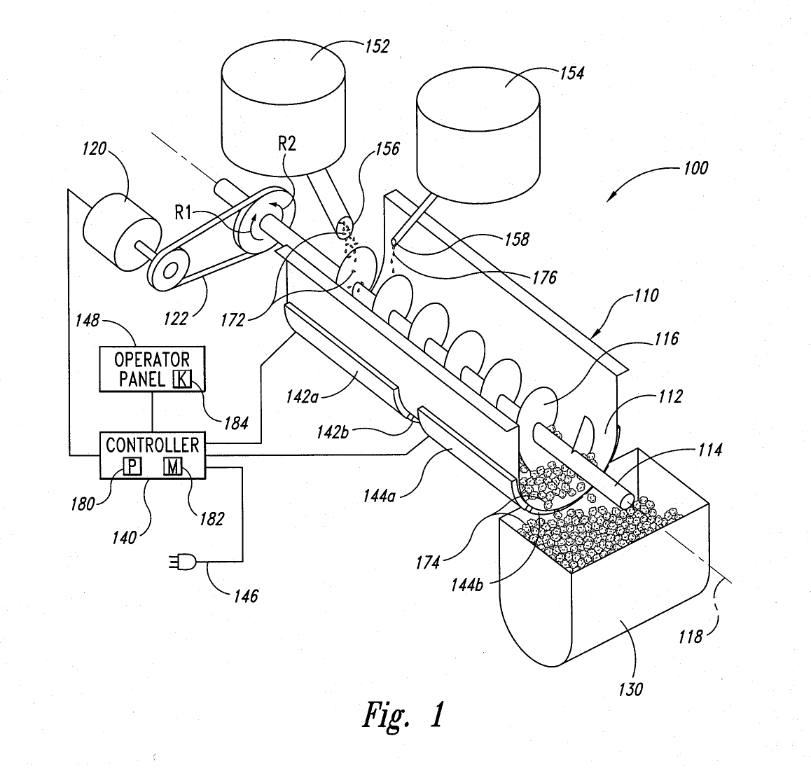

Certain details are set forth in the following description and in FIGS. 1-6 to provide a thorough understanding of various embodiments of the invention. Other details describing well-known structures and systems often associated with popcorn machines, rice puffing machines, snack puffing machines, etc. have not been set forth in the following disclosure to avoid unnecessarily obscuring the description of the various embodiments of the invention.

Many of the details, dimensions, angles and other features shown in the Figures are merely illustrative of particular embodiments of the disclosure. Accordingly, other embodiments can have other details, dimensions, angles and features without departing from the spirit or scope of the present invention. In addition, those of ordinary skill in the art will appreciate that further embodiments of the invention can be practiced without several of the details described below.

In the Figures, identical reference numbers identify identical, or at least generally similar, elements. To facilitate the discussion of any particular element, the most significant digit or digits of any reference number refer to the Figure in which that element is first introduced. For example, element 110 is first introduced and discussed with reference to FIG. 1.

FIG. 1 is a partially schematic isometric view of a food expanding machine 100 configured in accordance with an embodiment of the disclosure. In the illustrated embodiment, the food expanding machine 100 is a popcorn machine for popping raw corn kernels in, e.g., a large scale industrial setting. (Accordingly, for ease of reference the food expanding machine 100 will be referred to hereinafter as a popcorn machine 100). In other embodiments, however, the machine 100 and suitable variations thereof can be used for making other types of expanded food products such as puffed rice, puffed snacks (e.g., extruded starch snacks) and other types of expanded foods. Accordingly, while portions of the present disclosure may be directed to popcorn machines, it should be understood that various embodiments of the machines and methods described herein can be used to produce other types of expanded food products.

In the illustrated embodiment, the popcorn machine 100 includes a cooking assembly 110 having a heated cooking surface 112. The cooking surface 112 can include a metallic surface having a generally semi-circular cross-sectional shape in the form of a trough. In other embodiments, the cooking surface can have other shapes. The cooking surface 112 can be formed from stainless steel and/or other suitable metals known in the art. In some embodiments, the popcorn machine 100 and features thereof can be at least generally similar in structure and function to the popcorn machines described in U.S. patent application Ser. No. 11/942,648, filed Nov. 19, 2007, and entitled “POPCORN MACHINES AND OTHER MACHINES HAVING MULTIPLE HEAT ZONE COOKING SURFACES FOR PRODUCING POPCORN AND OTHER TYPES OF EXPANDED FOODS,” which is incorporated herein in its entirety by reference.

In the illustrated embodiment, a plurality of first heating elements 142 and second heating elements 144 are positioned proximate the underside of the cooking surface 112 to heat the cooking surface and pop, puff and/or expand food product placed thereon. Each of the heating elements 142, 144 can include a resistive wire (not shown) or other element encased in a metallic casing. Each of the resistive wires can receive electric power from a controller 140 that in turn receives electric power from a facility outlet via a power cord 146 to generate heat as known in the art. In other embodiments, other suitable heating elements (e.g., gas burners) known in the art in other arrangements can be used to heat the cooking surface 112.

A food moving device or auger 116 is operably positioned adjacent to the cooking surface 112. In one embodiment, the auger 116 has a helical or spiral blade with an outer diameter that is about the same, or slightly smaller, than the inner diameter of the semi-circular lower portion of the cooking surface 112. The auger 116 includes a central shaft 114 rotatably coupled to an electric motor 120 by means of a drive belt 122. The electric motor 120 is operably connected to the controller 140 and configured to rotate the auger 116 in two directions (e.g., clockwise and counterclockwise) about a longitudinal axis 118. In other embodiments, the auger 116 can be driven by a gear system, a direct drive system, etc.

In another aspect of this embodiment, the popcorn machine 100 includes a raw corn hopper/dispenser 152 and a cooking oil container/dispenser 154. The corn hopper 152 includes a corn feed outlet 156 that dispenses unpopped corn kernels 172 onto a first end portion of the cooking surface 112. Similarly, the cooking oil container 154 includes an oil feed outlet 158 that dispenses cooking oil 176 onto the cooking surface 112 to mix with the incoming corn kernels 172.

In the illustrated embodiment, an operator control panel 148 (shown schematically) having a keypad, one or more push-buttons or switches, and/or other user interface devices 184 is operably coupled to the controller 140. The controller 140 can include a processor 180 for executing computer-readable operating instructions stored on memory 182. The processor 180 can include a programmable logic controller (PLC) and/or other processing device suitable for executing computer-readable instructions for controlling operation of the popcorn machine 100 in accordance with operator input received via the control panel 148. For example, in one embodiment the operator may turn the popcorn machine 100 on/off, set popping time, set popping temperature, etc. via the control panel 148.

The controller 140 provides electric power to the heating elements 142, 144 and the electric motor 120 in response to operator inputs via the control panel 148. The electric power causes the motor 120 to rotate the auger 116 as the popcorn kernels 172 and cooking oil 176 are dispensed onto the cooking surface 112. For example, in one embodiment the auger 116 rotates in a first direction R1 (e.g., the forward direction) through a first phase or first angle of rotation (e.g., 360 degrees), and then reverses direction and rotates backward in a second direction R2 through a second phase or second angle of rotation (e.g., 300 degrees). This cycle continuously repeats as the popcorn and cooking oil mixture makes its way down the length of the heated cooking surface 112. Because the auger 116 rotates more in the first (forward) direction R1 and than in the second direction R2, the auger 116 ultimately drives the corn 172 over the entire length of the cooking surface 112. The back and forth motion of the auger 116 provides good agitation of the raw corn 172 and helps to keep the corn in the cooking oil 176. As it approaches the end portion of the cooking surface 112, the heated corn 172 begins to pop and become popcorn 174. The auger 116 drives the popcorn 174 out of the cooking assembly 110 and into a receptacle 130.

In a further aspect of this embodiment, the first heating elements 142 and the second heating elements 144 can provide two different heat zones on the cooking surface 112. For example, in some embodiments the first heating elements 142 can be heated to a first temperature ranging from about 350° F. to about 430° F., e.g., about 380° F., and the second heating elements 144 can be heated to a second temperature ranging from about 450° F. to about 500° F., e.g., about 480° F. In other embodiments, other operating temperatures can be selected for the first and second heating elements 142, 144 depending on the particular configuration of the cooking surface and/or other factors. In one embodiment, the first heating elements 142 can heat the corn kernels 172 on the first portion of the cooking surface 112 to a first temperature range of from about 72 degrees F. to about 380 degrees F., and the second heating elements 144 can heat the corn on the second portion of the cooking surface 112 to a second temperature range of from about 380 degrees F. to about 500 degrees F. As explained in U.S. patent application Ser. No. 11/942,684, operating a first heat zone at a first temperature and the second heat zone at a second, higher temperature provides gradual heating of the corn kernels 172 and prevents them from cooking too fast or too slow, resulting in a fully expanded popped corn without hard centers. In other embodiments, however, the cooking surface 112 can have one, two, or more heat zones heated to other temperatures in other ways. For example, in one embodiment the first heat zone can be operated at a higher temperature than the second, downstream heat zone. In other embodiments, the cooking surface 112 can have three or more heat zones. In further embodiments, the cooking surface 112 can be heated to a uniform or at least generally uniform temperature using only one heating element or one group of heating elements. Accordingly, the various popcorn machines and expanded food machines disclosed herein are not limited to a particular type of heated surface or heating device.

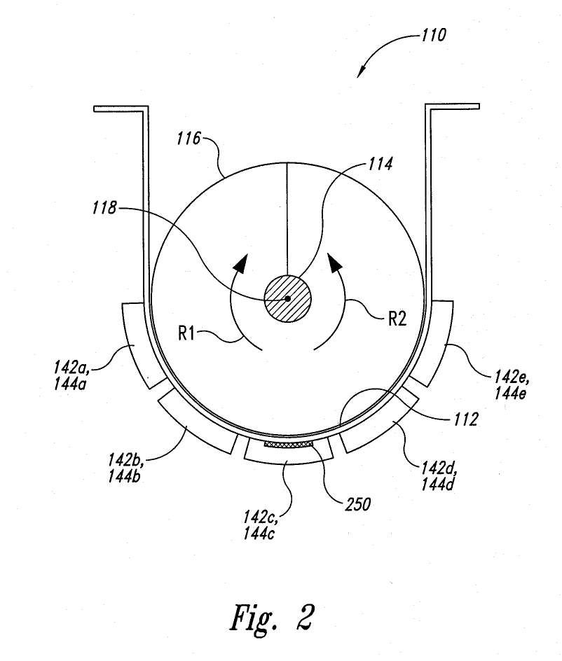

FIG. 2 is a partially schematic, enlarged end view of the cooking assembly 110 configured in accordance with an embodiment of the disclosure. As this view illustrates, the first heating elements 142 and second heating elements 144 can be aligned with each other, or at least approximately aligned with each other beneath the cooking surface 112. Moreover, the first heating elements 142 can include five individual heating elements (identified individually as first heating elements 142a-e) and the second heating elements 144 can include five individual heating elements (identified individually as second heating elements 144a-e). The heating elements 142, 144 can be radially spaced apart from each other around the semi-circular bottom portion of the trough-shaped cooking surface 112. In addition, one or more temperature sensors 250 (e.g., thermocouples, thermostats, etc.) can be operably coupled to the cooking surface 112 and to the controller 140 (FIG. 1) to actively monitor the temperature of the cooking surface 112. The controller 140 can utilize the information from the one or more temperature sensors 250 to control the power to the heating elements 142 and 144 to thereby control the temperature of the cooking surface 112.

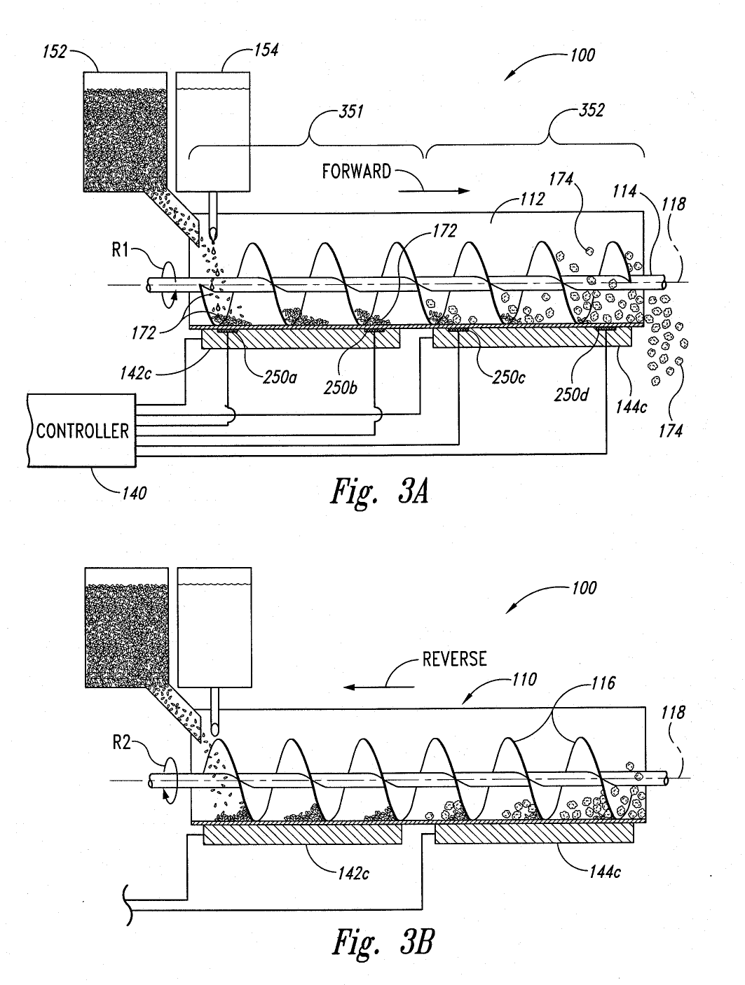

FIGS. 3A and 3B are partially schematic cross-sectional side views of the popcorn machine 100 configured in accordance with an embodiment of the disclosure. Referring first to FIG. 3A, a plurality of the temperature sensors 250 (identified individually as temperature sensors 250a-d) can be operably coupled to the underside (or proximate the underside) of the cooking surface 112 to provide temperature information to the controller 140. As described above, the controller 140 can control electric power to the first heating elements 142 and the second heating elements 144 based on the temperature information received from the temperature sensors 250. For example, the controller 140 can distribute electric power to the first heating elements 142 and the second heating elements 144 to provide a first heat zone 351 on a first portion of the cooking surface 112 and a second, higher temperature heat zone 352 downstream of the first heat zone 351. In one embodiment, the first heat zone 351 can have a first surface temperature ranging from about 350° F. to about 430° F., e.g., about 380° F. The second heat zone 352 can have a second surface temperature ranging from about 450° F. to about 500° F., e.g., about 480° F. Providing stepped or increasingly hotter heat zones on the cooking surface 112 gradually heats the raw popcorn 172 and provides favorable popping characteristics.

As explained above, in one embodiment the auger 116 can rotate in the first or forward direction R1 for about 360 degrees, then rotate in the reverse direction R2 for about 300 degrees, and then repeat the cycle. FIG. 3A illustrates how the auger 116 moves the raw popcorn 172 forward when the auger 116 rotates in the first direction R1. FIG. 3B illustrates how the auger 116 moves the raw popcorn 172 backward when the auger 116 rotates in the second direction R2.

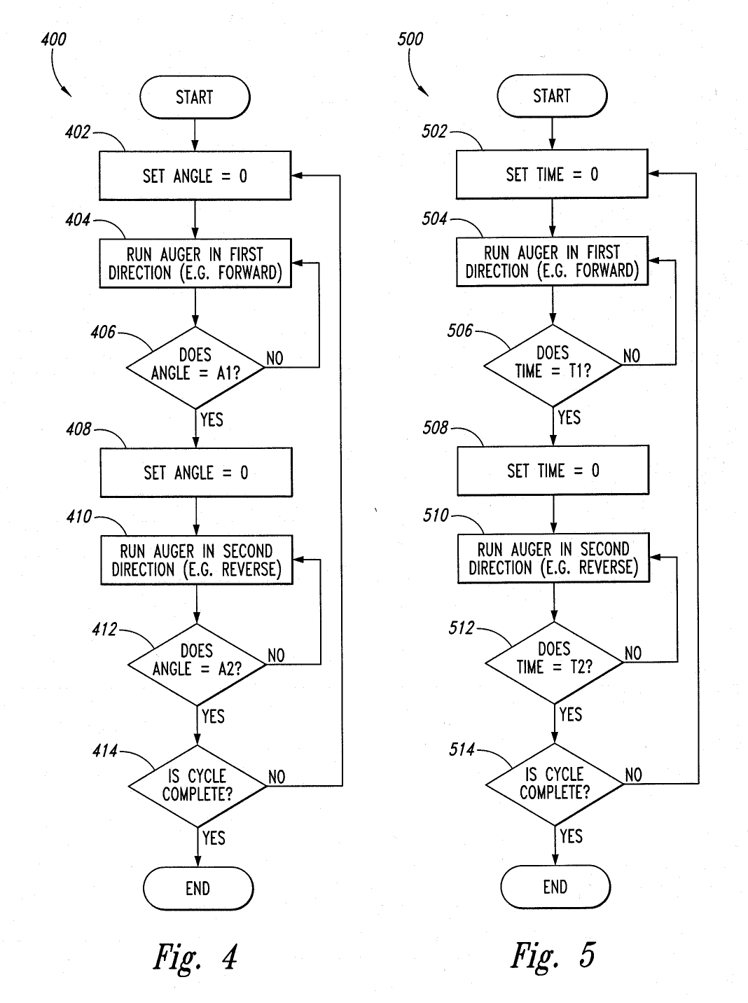

FIG. 4 is a schematic diagram of a flow routine 400 for operating a popcorn machine having a reversible food moving device in accordance with an embodiment of the disclosure. In one embodiment, the routine 400 or portions thereof can be performed by the processor 180 in the controller 140 of the popcorn machine 100 in accordance with computer-readable instructions stored in the memory 182 (FIG. 1). In other embodiments, the routine 400 can be utilized by other popcorn machines and other machines for producing expanded food products.

After the operator has turned the popcorn machine (e.g., the popcorn machine 100) “on” and provided the necessary operating inputs, the routine begins in block 402 by initializing or setting the angle of auger rotation to zero degrees. In block 404, the auger begins to rotate in a first direction (e.g., the forward direction or the direction that drives the food product forward on the cooking surface). In decision block 406, the routine determines if the auger has rotated through an angle of A1 degrees. For example, in one embodiment the angle A1 can be from about 340 degrees to about 380 degrees, or about 360 degrees. If the auger is not rotated through an angle of 360 degrees, the routine returns to block 404 and continues to rotate the auger in the first direction. Once the auger has rotated in the first direction through an angle A1 of 360 degrees, the routine proceeds to block 408 and resets the measurement of auger angle back to zero.

In block 410, the routine begins rotating the auger in the second direction to move food product (e.g., corn kernels) backward on the cooking surface. In decision block 412, the routine determines if the auger has turned through an angle of A2 degrees in the second direction. For example, in one embodiment the angle A2 can be from about 260 degrees to about 340 degrees, or about 300 degrees. If the auger has not rotated through an angle of 300 degrees in the second direction, the routine returns to block 410 and continues to rotate the auger in the second direction. Once the auger has rotated through an angle of 300 degrees in the second direction, the routine proceeds to decision block 414 to determine if the selected cooking cycle for the particular quantity and/or type of food product is complete. For example, in one embodiment the routine can determine if there is any more corn on the cooking surface to pop. If the cooking cycle is not complete, the routine returns to block 402 and repeats the cycle of running the auger in the first direction and then in the reverse direction. When the cooking cycle is complete (e.g., when all the food product has been popped or otherwise expanded, when the operator turns the popcorn machine “off,” etc.) the routine ends.

FIG. 5 is a schematic diagram of a flow routine 500 that is at least generally similar to the flow routine 400 described above. In this embodiment, however, rather than measure the phase or the amount of auger rotation in a particular direction, the routine measures the amount of time that the auger has rotated in a particular direction. For example, after the operator has turned the popcorn machine “on” and set the desired cooking parameters, the routine proceeds to block 502 and initializes the time of auger rotation to zero. In block 504, the routine begins rotating the auger in the first direction (e.g., forward). In decision block 506, the routine determines if the auger has rotated in the first direction for a time period equal to T1. In one embodiment, for example, the elapsed time T1 can be about the amount of time it takes for the auger to rotate through 360 degrees, which will vary depending on the rotational speed of the auger. In other embodiments, however, the time period T1 can be set to other periods of time.

If the auger has not rotated in the first direction for the predetermined amount of time, then the routine returns to block 504 and continues to rotate the auger in the first direction. Once the auger has rotated in the first direction for the time period T1, the routine proceeds to block 508 and resets the elapsed time to zero. In block 510, the auger is then run in the second direction (e.g., reverse). In block 512, the routine determines if the auger has rotated in the second or reverse direction for a predetermined second period of time T2. In one embodiment, for example, the elapsed time T2 can be about the amount of time it takes for the auger to rotate through 300 degrees. If the auger has not rotated in the second direction for the period of time T2, the routine returns to block 510 and continues to rotate the auger in the second direction. Once the auger has rotated in the second direction for the second period of time T2, the routine proceeds to decision block 514 to determine if the cooking cycle is complete. If not, the routine returns to block 502 and repeats the cycle of alternating auger rotation as described above. Once the cooking cycle is complete, the routine 500 ends.

Although the foregoing embodiments describe alternating periods of auger rotation corresponding to 360 degrees of rotation in the forward direction and 300 degrees of rotation in the reverse direction, in other embodiments the auger or other food moving device can rotate or otherwise move back and forth for other time periods and/or other distances. For example, in other embodiments the auger can rotate forward for 270 degrees and backward for 180 degrees. Accordingly, the present disclosure is not limited to the particular phases, angles, and/or time periods described above, and contemplates a wide variety of operational parameters.

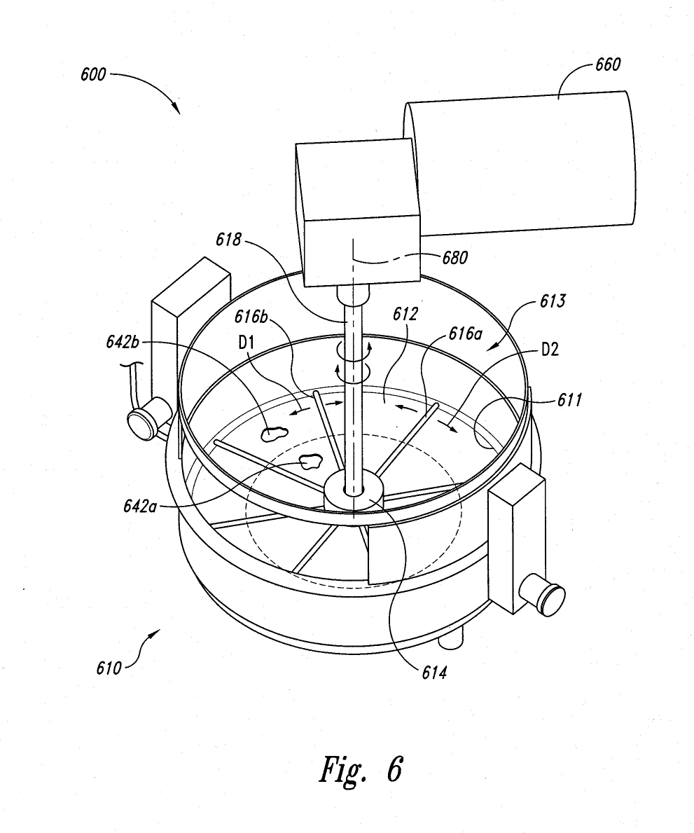

Although the foregoing description of reversible food moving devices have been described above in the context of a linear popcorn machine having a trough-shaped cooking surface, the various aspects and features of the reversible food moving devices described above can also be employed in other types of popcorn machines and food expanders in accordance with the present disclosure. FIG. 6, for example, is a partially schematic isometric view of a portion of a popcorn machine 600 having a kettle assembly 610 configured in accordance with another embodiment of the disclosure. By way of example, the kettle assembly 610 can be at least generally similar in structure and function to the kettle assemblies and related devices disclosed in international PCT Patent Application No. PCT/EP2005/009010 (Publication No. WO 2006/021387 A1), filed Aug. 19, 2005 (claiming priority to DE Patent Application No. 10 2004040662.6, filed Aug. 20, 2004), entitled “METHOD AND DEVICE FOR THE PRODUCTION OF EXPANDED FOOD,” which is incorporated herein in its entirety by reference.

In the illustrated embodiment, the kettle assembly 610 includes a heating vessel or pan 611 having a popping surface 612 positioned above heating elements 642a,b. A food moving device 613 is operably positioned inside the pan 611. In the illustrated embodiment, the food moving device 613 includes a plurality of rod-like stirring blades or rakes 616 (identified individually as rakes 616a-i) which extend outwardly from a central hub 614 in a radial pattern. In other embodiments, however, the rakes 616 can include paddle-like surfaces that extend upwardly from the popping surface 612. These surfaces and/or rakes can help push the popcorn out of the kettle assembly 610 after popping. The rakes 616 rotate about a central axis 680 by means of a drive shaft 618 which is operably coupled to the hub 614. The drive shaft 618 is in turn driven by an electric motor 660.

In operation, the electric motor 660 rotates the rakes 616 about the central axis 680 in a first direction D1 as corn kernels and cooking oil (not shown) are fed onto the popping surface 612. As the rakes 616 rotate, they move the unpopped corn kernels outwardly on the popping surface 612 away from the hub 614. In one aspect of this embodiment, after rotating the rakes 616 in the first direction D1 a first predetermined amount, the electric motor 660 can reverse direction of the shaft 618 and rotate the rakes 616 in a second direction D2 for a second predetermined period of time. As described above with regard to the linear popcorn machine 100, reversing direction of the rakes 216 can keep the unpopped corn kernels suitably mixed with the cooking oil and provide other desirable popping characteristics.

From the foregoing, it will be appreciated that specific embodiments of the invention have been described herein for purposes of illustration, but that various modifications may be made without deviating from the spirit and scope of the various embodiments of the invention. Further, while various advantages associated with certain embodiments of the invention have been described above in the context of those embodiments, other embodiments may also exhibit such advantages, and not all embodiments need necessarily exhibit such advantages to fall within the scope of the invention. Accordingly, the invention is not limited, except as by the appended claims.

I/We claim:

1. A machine for making popcorn, the machine comprising:
a cooking surface configured to support a plurality of unpopped corn kernels;
one or more heating elements positioned proximate the cooking surface to heat the cooking surface; and
a food moving device operably positioned adjacent the cooking surface, wherein the food moving device is configured to move the unpopped corn kernels across the cooking surface by moving the unpopped corn kernels in a first direction, then changing direction and moving the unpopped corn kernels in a second direction, and then changing direction again and moving the unpopped corn kernels in the first direction.

2. The machine of claim 1 wherein the first direction is opposite to the second direction.

3. The machine of claim 1 wherein the food moving device is configured to repeat the cycle of moving the unpopped corn kernels back and forth in the first and second directions.

4. The machine of claim 1 wherein the food moving device is configured to repeat a cycle of moving the unpopped corn kernels a first distance in the first direction and then moving the unpopped corn kernels a second distance, less than the first distance, in the second direction.

5. The machine of claim 1 wherein the food moving device is configured to move the unpopped corn kernels a first distance in the first direction, reverse direction a first time and move the unpopped corn kernels a second distance in the second direction, and then reverse direction a second time and move the unpopped corn kernels a third distance in the first direction, wherein the third distance is greater than the second distance.

6. The machine of claim 1 wherein the food moving device includes a rotatable auger having a helical blade that moves the unpopped corn kernels.

7. The machine of claim 1 wherein the food moving device includes a plurality of rakes extending outwardly from a central hub, and wherein the rakes rotate about a central axis extending through the central hub to move the unpopped corn kernels.

8. The machine of claim 1 wherein the cooking surface has a semi-circular cross-sectional shape with an inner diameter, and wherein food moving device includes a rotatable auger having a helical blade with a outer diameter that is at least approximately equal to or smaller than the inner diameter of the cooking surface.

9. The machine of claim 1, wherein the cooking surface has a semi-circular cross-sectional shape, wherein food moving device includes a rotatable auger having a helical blade oriented on a longitudinal axis, and wherein the machine further comprises a reversible drive system operably coupled to the rotatable auger, wherein the reversible drive system is configured to rotate the auger in a first direction about the longitudinal axis to move the unpopped corn kernels in the first direction, and wherein the reversible driver system is further configured to rotate the auger in a second direction, opposite to the first direction, to move the unpopped corn kernels in the second direction.

10. A machine for producing expanded food, the machine comprising:
a food heating surface;
one or more heating elements positioned proximate an underside of the heating surface;
a hopper configured to dispense unexpanded food onto a first portion of the heating surface; and
a reversible food moving device operably positioned adjacent the heating surface, wherein the reversible food moving device is configured to move the unexpanded food from the first portion of the heating surface toward a second portion of the heating surface by repeatedly moving the unexpanded food forward a first distance and then reversing direction and moving the unexpanded food back a second distance, less than the first distance.

11. The machine of claim 10 wherein the heating surface forms a trough, wherein the reversible food moving device includes a rotating auger having a helical blade disposed in the trough, wherein the helical blade rotates in a first direction to move the unexpanded food forward on the heating surface, and wherein the helical blade rotates in a second direction, opposite to the first direction, to move the unexpanded food backward on the heating surface.

12. The machine of claim 11 wherein the one or more heating elements include a first heating element and a second heating element, wherein the first heating element is configured to heat the first portion of the heating surface to a first operating temperature, and wherein the second heating element is configured to heat the second portion of the heating surface to a second operating temperature, different than the first temperature.

13. The machine of claim 11 wherein the heating surface includes a first heat zone operable at a first temperature and second heat zone operable at a second, higher temperature, wherein the reversible food moving device includes a rotating auger that moves the unexpanded food from the first heat zone to the second heat zone by cyclically rotating in a first direction to move the unexpanded food forward on the heating surface and rotating in a second direction to move the unexpanded food backward on the heating surface.

14. The machine of claim 11, further comprising means for periodically reversing the direction of the food moving device.

15. A method of operating a machine for producing expanded food, the method comprising:
(a) heating a cooking surface;
(b) dispensing unexpanded food onto the cooking surface;
(c) moving the unexpanded food a first distance in a first direction on the cooking surface;
(d) after moving the unexpanded food the first distance, reversing direction and moving the unexpanded food a second distance in a second direction on the cooking surface, wherein the second direction is opposite to the first direction and the second distance is less than the first distance; and
(e) repeating steps (c) and (d).

16. The method of claim 15 wherein moving the unexpanded food a first distance in a first direction includes rotating an auger in a clockwise direction, and wherein moving the unexpanded food a second distance in a second direction includes rotating the auger in a counter-clockwise direction.

17. The method of claim 15 wherein moving the unexpanded food a first distance in a first direction includes rotating a plurality of rakes in a clockwise direction about a central axis, wherein the plurality of rakes extend radially outward from the central axis, and wherein moving the unexpanded food a second distance in a second direction includes rotating the plurality of rakes in a counter-clockwise direction about the central axis.

18. The method of claim 15 wherein moving the unexpanded food a first distance on the cooking surface includes moving the unexpanded food on a concave cooking surface.

19. The method of claim 15 wherein heating the cooking surface includes heating a first portion of the cooking surface to a first temperate and heating a second portion of the cooking surface to a second temperature, higher than the first temperature, and wherein repeatedly moving the unexpanded food in the first and second directions on the cooking surface moves the unexpanded food from the first portion of the cooking surface to the second portion of the cooking surface.

20. The method of claim 15 wherein dispensing unexpanded food onto the cooking surface includes dispensing unpopped corn kernels onto the cooking surface.

21. The method of claim 15 wherein dispensing unexpanded food onto the cooking surface includes dispensing starch snack foods onto the cooking surface.
